(19) United States
(12) Patent Application Publication
(10) Pub. No.: US 2012/0261572 A1
(43) Pub. Date: Oct. 18, 2012

(54) INSPECTION SYSTEM

(76) Inventor: Roland Schmidt, Erlangen (DE)

(21) Appl. No.: 13/447,580

(22) Filed: Apr. 16, 2012

(30) Foreign Application Priority Data
Apr. 15, 2011 (DE) 10 2011 007 503.8

(51) Int. Cl. G01N 23/02

(52) U.S. Cl. 250/306

(57) ABSTRACT

An inspection system has at least one radiation source and at least one L-shaped radiation detector for radioscopy of an article to be inspected. The radiation detector has a horizontal detector surface and a vertical detector surface and the radiation source is spaced apart from both detector surfaces. The inspection system is given a simple design by the horizontal detector surface running below the article being inspected and the radiation source being arranged in an upper corner position.

### BACKGROUND OF THE INVENTION

1. Field of the Invention

The invention concerns an inspection system.

2. Description of the Prior Art

An inspection system is known from FIGS. 20 and 27 of EP 1 635 169 B1. This known inspection system is designed as a mobile inspection system and is installed on a vehicle. The inspection system according to EP 1 635 169 B1 has at least one radiation source and at least one radiation detector (L-shaped during the inspection) for a fan-shaped radioscopy of an article [subject] to be inspected. The radiation detector possesses a vertical detector surface that is arranged in a vertical support and a horizontal detector surface that is arranged in a horizontal support. The radiation source is spaced apart from both detector surfaces.

The horizontal detector surface travels over the article to be inspected, and the radiation source (which is executed as a LINAC; Linear Accelerator) is arranged such that it can pivot in a lower (floor-side) corner position. For this purpose, the radiation source is mounted so that is movable either at a free end of a vertical telescoping arm (see FIG. 20) or on the vehicle (see FIG. 27). The vertical detector surface and the horizontal detector surface thus form a virtual gate through which the article to be inspected is moved during its inspection. A nearly complete radioscopy of the article to be inspected is ensured by the described arrangement of the detector surfaces and the radiation source.

Inspection systems of the aforementioned type serve to inspect the content of containers and vehicles and compare them with the information in the shipping documents, for example. Contraband can therefore be detected cost-effectively and simply.

In order to achieve high-resolution imaging, the vertical support in which the vertical detector surface is arranged and the horizontal support in which the horizontal detector surface is arranged must be executed so as to be warp-resistant. This requires a complicated mechanical design that leads to a correspondingly high weight of the support to be moved.

### SUMMARY OF THE INVENTION

An object of the present invention is to provide an inspection system having a construction of simpler design that of the known system described above.

The inspection system according to the invention has at least one radiation source and at least one L-shaped radiation detector for a radioscopy of an article to be inspected, wherein the radiation detector has a horizontal detector surface and a vertical detector surface and the radiation source is spaced apart from both detector surfaces. According to the invention, the horizontal detector surface runs below the article to be inspected and the radiation source is arranged at an upper corner position.

In the inspection system according to the invention, the horizontal detector surface and the vertical detector surface thus likewise form a virtual gate through which the article to be inspected is moved during its inspection.

Instead of mounting the radiation source at the floor-side corner of the detector gate formed by the L-shaped radiation detector, the radiation source is arranged in the upper corner position. Before the beginning of the inspection the horizontal radiation detector is placed at the floor (for example the roadway surface), in contrast to which the radiation detector that forms the second leg of the L-shaped radiation detector is arranged similar to as in the inspection device known from EP 1 635 169 B1. The radioscopy angle generated by the radiation source is therefore essentially rotated one corner further (by 90°), wherein the complete radioscopy area is maintained.

In the invention, the known projection and radioscopy scheme is thus reversed. The radiation cone of the radiation source is therefore directed downwardly so that the radiation takes place in the base, so any leakage radiation into the environment is markedly reduced.

Furthermore, the inspection system according to the invention has a simpler mechanical design since the horizontal radiation detector can now rest flat on the floor and be stably aligned. A greater stability likewise results for the vertical radiation detector due to the L-shaped arrangement. A complicated and heavy design is thus no longer necessary. The solution according to the invention is therefore also suitable for mobile applications (claim 9) in which the complete inspection system is transported on a road or rail vehicle or, respectively, is installed on this, for example.

In embodiments, the horizontal detector surface is arranged in a horizontal support and/or the vertical detector surface is arranged in a vertical support.

In a further preferred embodiment, the horizontal detector surface extends transverse to a direction of movement of the article to be inspected.

In another embodiment the horizontal detector surface is protected by ramps. In this case, damage to the horizontal radiation detector or, respectively, the horizontal support when the article being inspected passes over is reliably prevented.

If the articles to be inspected are of large volume and/or have high masses—as this is the case given containers or vehicles, for example—it is then advantageous to design the radiation source as a LINAC (linear particle accelerator). Due to its energy of approximately 3 MeV to approximately 6 MeV, such a radiation source delivers a sufficiently good image quality of the region to be inspected, even in the case of thicker material.

In a further embodiment the radiation source can be shifted vertically. For example, this can be realized by a simple lifting device via which the radiation source can be raised to the upper corner position, for example.

With an arrangement of the radiation source (claim 8) that can be pivoted, a complete radioscopy is possible, particularly with a vertical displacement capability, even in the case of articles of large volume.

### BRIEF DESCRIPTION OF THE DRAWINGS

FIG. 1 schematically illustrates an embodiment of the inspection system according to the invention.

FIG. 2 shows a detail of the inspection system according to FIG. 1.

### DESCRIPTION OF THE PREFERRED EMBODIMENTS

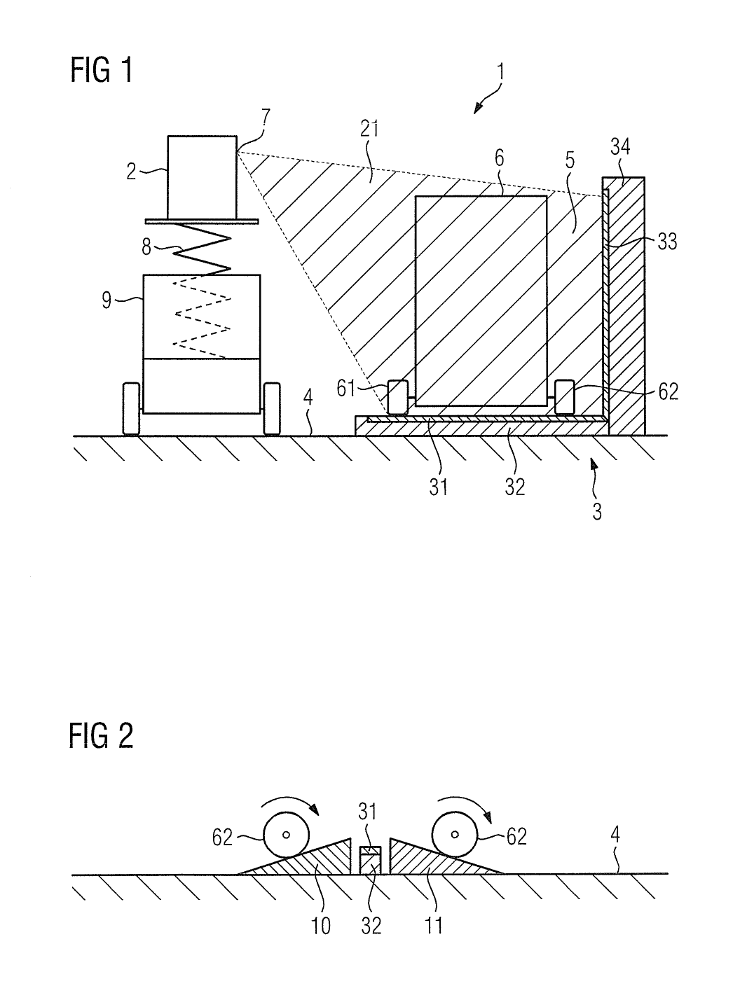

The embodiment of the inspection system according to the invention that is presented in FIG. 1 is executed as a mobile inspection system 1.

In the shown exemplary embodiment, the inspection system 1, that is shown in its operating position, has a radiation source 2 and an L-shaped radiation detector 3.

The radiation source 2 is designed as a LINAC (Linear Accelerator) and emits the radiation in the form of a radiation cone 21.

The radiation detector 3 has a horizontal detector surface 31 that is arranged in a horizontal support 32 that is placed on the floor 4 (roadway surface) in the operating position.

The radiation detector 3 furthermore has a vertical detector surface 33 that is arranged in a vertical support 34.

The horizontal support 32 and the vertical support 34 are arranged at right angles to one another. The horizontal detector surface 31 and the vertical detector surface 33 therefore form a detector gate 5 (“virtual gate”).

For implementing an inspection, an article 6 to be inspected is moved through the detector gate 5. In the present case, the article 6 to be inspected is a truck that has wheels 61 and 62.

In the shown exemplary embodiment, the radiation source 2 is arranged so that it can be displaced vertically and pivoted on a corresponding lifting platform 8.

According to the invention, the radiation source 2 is spaced apart from the two detector surfaces 31 and 33, and in the shown exemplary embodiment it is displaced vertically into an upper corner position 7.

Since—for inspection of the truck 6—the radiation source 2 is arranged in an upper corner position 7, the horizontal detector surface 31 runs below the truck 6 and the vertical detector surface 33 is arranged vertically next to the truck 6, according to the invention the radiation cone 21 is therefore directed downward so that the radiation into the floor 4 takes place, so leakage radiation exposure in the environment is markedly reduced. In the invention the known projection and radioscopy scheme is thus reversed.

The inspection device presented in FIG. 1 is designed as a mobile inspection device. For this the lifting platform 8 is installed on a (self-propelled) vehicle, for example on a road vehicle or a rail vehicle. However, the solution according to the invention that leads to a radiation cone 21 directed downward can also be realized given stationary inspection devices.

Moreover, given an inspection device arranged on a vehicle the inventive reversal of the projection and radioscopy scheme has the further advantage that the edges near the floor (roadway, rail) and the lower edge of the vehicle chassis that occur in an inspection device according to EP 1 635 169 B1 and that are critical to imaging are not present.

In the shown embodiment, the horizontal detector surface 31 extends transversal to a direction of movement of the article 6 to be inspected. Therefore, it is advantageous (as shown in FIG. 2) to protect the horizontal detector surface 31 (that is arranged in a horizontal support 32) via ramps 10, 11 against contact by the wheels 61 and 62 of the truck 6. Only the wheel 62 is visible in FIG. 2 due to the selected presentation.

Although modifications and changes may be suggested by those skilled in the art, it is the intention of the inventor to embody within the patent warranted hereon all changes and modifications as reasonably and properly come within the scope of his contribution to the art.

I claim as my invention:

1. An inspection system comprising:
at least one radiation source that emits a beam of penetrating radiation;
at least one L-shaped radiation detector located in said beam path, and configured to detect radiation from said at least one radiation source attenuated by an article located in said radiation beam, said radiation detector comprising a horizontal detector surface and a vertical detector surface forming said L-shaped; and
said at least one radiation source being spaced from both said horizontal and vertical detector surfaces, and said horizontal detector surface being configured to proceed beneath said article with said radiation detector located above a corner of said L-shape.

2. An inspection system as claimed in claim 1 comprising a horizontal support that supports said horizontal detector surface.

3. An inspection system as claimed in claim 1 comprising a vertical support that supports said vertical detector surface.

4. An inspection system as claimed in claim 1 wherein said article is movable in a movement direction, and wherein said horizontal detector surface is configured to proceed transversely to said movement direction.

5. An inspection system as claimed in claim 1 wherein said horizontal detector surface has a leading edge and a trailing edge, and comprising respective ramps located at each of said leading edge and trailing edge configured to allow said article to move onto and off of said horizontal detector surface via the respective ramps.

6. An inspection system as claimed in claim 1 wherein said radiation source is a linear particle accelerator.

7. An inspection system as claimed in claim 1 comprising a mount on which said radiation source is mounted, said mount being configured to vertically displace said radiation source.

8. An inspection system as claimed in claim 1 wherein said mount is also configured to pivot said radiation source.

9. An inspection system as claimed in claim 1 comprising a vehicle on which said radiation source is mounted, said vehicle being configured to be positioned adjacent said L-shaped radiation detector.
